(19) United States
(12) Patent Application Publication
(10) Pub. No.: US 2016/0151246 A1
(43) Pub. Date: Jun. 2, 2016

(54) Medicine Reminder and Dispenser Apparatus

(71) Applicant: Jose Sotelo, Morton Grove, IL (US)

(72) Inventor: Jose Sotelo, Morton Grove, IL (US)

(21) Appl. No.: 14/937,820

(22) Filed: Nov. 10, 2015

Related U.S. Application Data
(60) Provisional application No. 62/077,797, filed on Nov. 10, 2014.

(51) Int. Cl. A61J 7/04; A61J 7/00

(52) U.S. Cl. CPC A61J 7/04; A61J 7/0069; A61J 7/0007

(57) ABSTRACT

A Medicine Reminder and Dispenser Apparatus for dispensing medications to a user is provided. The Apparatus comprises a substantially rectangular, tabletop device having a top side, a bottom side, a front side, a rear side, a first side, and a second side. A medication receiving opening is formed in the front side and a first compartment is formed in the top side. A plurality of individual medication wells are positioned within the first compartment with each medication well openable for releasing the medication into the medication opening. A programming mechanism mounted on the device programs dispensing of medication from each medication well and audio and visual reminders as to when a certain medication is to be taken or administered. The device provides a digital daily, weekly or monthly medicine dispenser.

### CLAIM OF PRIORITY

This patent application claims priority under 35 USC 119 (e) (1) from U.S. Provisional Patent Application Ser. No. 62/077,797 filed Nov. 10, 2014, of common inventorship herewith entitled, “Medicine Reminder and Dispenser.”

### FIELD OF THE INVENTION

The present invention pertains to the field of medicinal aids, and more specifically to the field of pill storing and dispensing organizers.

### BACKGROUND OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention.

Most inventions fill a relatively small need or perform a specialized limited function. If that need is shared by a sufficient number of consumers, an invention has a great potential for success. Many individuals rely upon a timed dosage of multiple medications. Whether an individual must keep track of their own medications or they have a relative or caregiver to keep track, it is extremely important to take medications on time and as prescribed. With multiple medicines on different dosing schedules, managing one's medication schedule becomes an almost full time job. For individuals with swallowing problems or nasogastric feeding tubes, their pills are crushed and administered in a matrix like applesauce or administered as a liquid through the feeding tube.

The prior art has put forth several designs for pill storing and dispensing organizers. Among these are:

US Patent 2012/0006847 to Matthew Coe describes interactive medicine organizers comprising multifunctional interactive wireless devices such as cell phones having programmable software that communicate with one or more medicine dispensers and methods for monitoring and improving patient compliance with medication schedules. In one aspect of the invention, the apparatus comprises a dispenser body. The body includes housing with a connectable loading door, multi chambered tray, dispensing door and docking station. A multifunctional interactive wireless device is capable of docking with the docking station, commanding the tray to a plurality of positions, commanding the loading door to a plurality of positions and commanding the dispensing door to a plurality of positions. The device executes a software application for determining a plurality of positions of the tray, the loading door and the dispensing door based on a data set input by a user.

US Patent 2009/0281657 to Alexander Gak and Mirek Bogdanowicz Msee describes a medication reminder and dispensing system that includes a computing or electronic device for programming a medication regimen such as a prescription. A docking station downloads the medication regimen and stores the medication. A personal medicine container holds a daily or weekly supply of the medication and receives the medication regimen. The personal medicine container is carried by a user and includes an alarm for reminding the user to take or administer the medicine in accordance with the medication regimen.

U.S. Pat. No. 5,159,581 to Rita M. Agans describes a medicine reminder and dispensing apparatus having a plurality of containers arranged in rows and columns in a cabinet. Each container comprises a slidable base plate and a fixed wall, a drive apparatus for driving said slidable base plate in each of two directions and a microprocessor to control the dispensing apparatus in operation. An alarm connected to the microprocessor alerts a user that it is time to take or dole out a predetermined dose of medication. Push button inputs identify selected times for dispensing medication and a reset apparatus resets the base plates while the containers are resupplied. A top cover of the cabinet is lockable to prevent premature access to medication stored in the cabinet.

None of these prior art references describe the present invention.

### SUMMARY OF THE INVENTION

It is an object of the present invention to provide a compact, self-contained, electrically powered, digital programmable device that contains, organizes and dispenses multiple individual medications on a preprogrammed dosing schedule.

The present invention is a Medicine Reminder and Dispenser Apparatus for dispensing medications to a user is provided. The Apparatus comprises a substantially rectangular, tabletop device having a top side, a bottom side, a front side, a rear side, a first side, and a second side. A medication receiving opening is formed in the front side and a first compartment formed in the top side. A plurality of individual medication wells is positioned within the first compartment with each medication well openable for releasing the medication into the medication opening. A programming mechanism mounted on the device programs dispensing of medication from each medication well and audio and visual reminders as to when a certain medication is to be taken or administered. The device provides a digital daily, weekly or monthly medicine dispenser.

In addition, the present invention includes a method for dispensing medications to a user. The method comprises providing a substantially rectangular, tabletop device having a top side, a bottom side, a front side, a rear side, a first side, and a second side, forming a medication receiving opening in the front side, forming a first compartment formed in the top side, positioning a plurality of individual medication wells within the first compartment, releasing the medication into the medication opening, programming dispensing of medication from each medication well and audio and visual reminders as to when a certain medication is to be taken or administered, and providing a digital daily, weekly or monthly medicine dispenser.

The present invention further includes Medicine Reminder and Dispenser Apparatus for dispensing medications to a user. The Apparatus comprising a substantially rectangular, tabletop device having a top side, a bottom side, a front side, a rear side, a first side, and a second side. A medication receiving opening is formed in the front side and a first compartment is formed in the top side. A plurality of individual medication wells is positioned within the first compartment with each medication well openable for releasing the medication into the medication opening. A second compartment is formed in the top side of the device with at least one syringe positionable within the second compartment. A third compartment is formed in the top side of the device with a pill pulverizer mounted within the third compartment. An opening is formed in the first side of the device and fluidly connected to the pill pulverizer such that the pulverized pill falls into the opening. Programming means are mounted on the device for programming dispensing of medication from each medication well, dispensing a syringe from the second compartment, and audio and visual reminders as to when a certain medication is to be taken or administered.

### BRIEF DESCRIPTION OF THE DRAWINGS

FIG. 1 is a prototypical diagonal front view of the present invention showing a display LED or LCD touch screen and a common dispenser component.

FIG. 2 is a prototypical diagonal front and side view of the present invention showing medicine wells, an LED touch screen, a common dispenser component, a pulverizing component and an insulin syringe preparation component.

FIG. 3 is a prototypical side view of the present invention showing the component in which pills are pulverized for patients who have difficulty swallowing pills.

FIG. 4 is a prototypical diagonal side view of the present invention showing a refrigerated component in which an insulin syringe is prepared weekly or monthly depending on patient need.

FIG. 5 is a prototypical top down diagonal view of the present invention showing a storage component with individual medicine wells.

FIG. 6 is a prototypical diagonal front view of a wireless speaker that is placed in a patient's room or a caregiver's room to audibly remind them the medicine is ready.

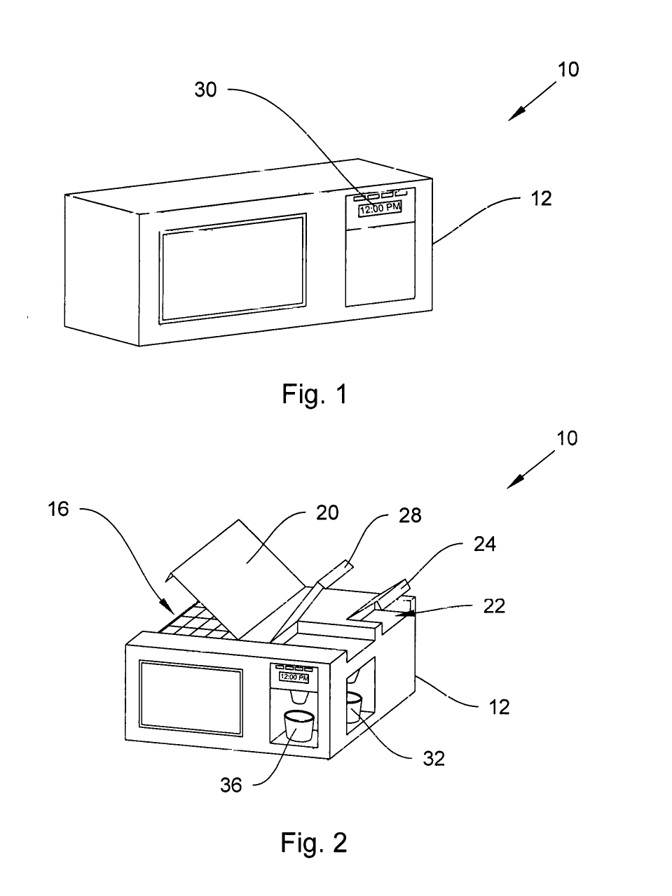

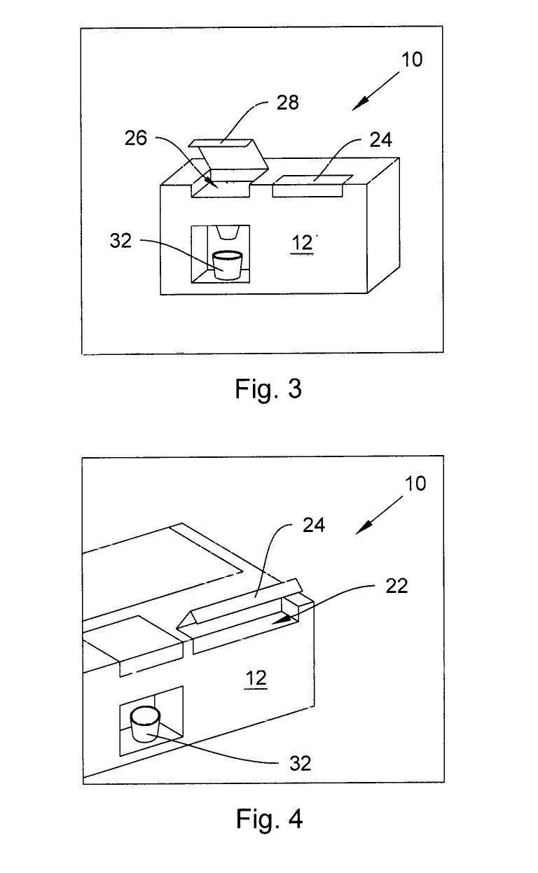

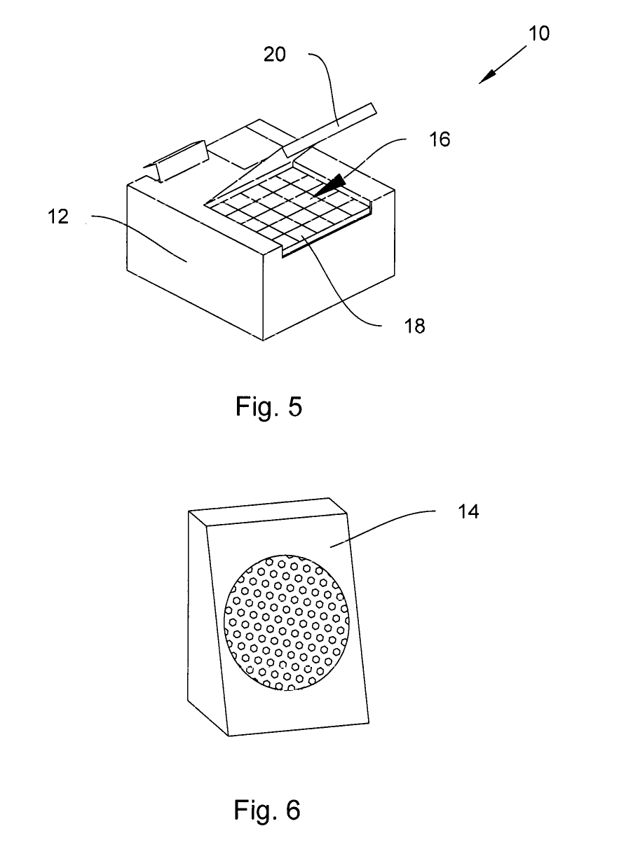

### DETAILED DESCRIPTION OF THE INVENTION

The present invention, hereinafter referred to as the Medicine Reminder and Dispenser Apparatus, indicated generally at 10, helps aforementioned individuals or their caregivers immensely by organizing medications, providing reminders when the medicines are to be taken, dispensing the medicines and even pulverizing the pills as needed. The present invention is a digital daily, weekly or monthly medicine dispenser 12, comprised of programmable timing with audio and visual reminders to alert an individual or their caregiver when a certain medication is to be taken or administered. The Medicine Reminder and Dispenser Apparatus 10 is a compact, self-contained, electrically powered, digital programmable device 12 that contains, organizes and dispenses multiple individual medications on a preprogrammed dosing schedule. The alert is transmitted through a wireless, mobile audio speaker 14. The present invention pulverizes pills when necessary for administering the medication to the patient.

The Medicine Reminder and Dispenser Apparatus 10 of the present invention is a rectangular countertop or tabletop device 12 that preferably measuring approximately ten inches in height, approximately eleven inches in length, and approximately three inches in width. It should be noted that while the Medicine Reminder and Dispenser Apparatus 10 has been described as having particular dimensions, it is within the scope of the present invention for the device 12 of the Medicine Reminder and Dispenser Apparatus 10 to have larger or smaller dimensions.

The Medicine Reminder and Dispenser Apparatus 10 of the present invention has a top side, a bottom side opposite the top side, a front side, a rear side opposite the front side, a first side between the front side and the rear side, and a second side opposite the first side. The top side has a first compartment 16 formed therein for receiving a plurality of medication wells 18 with a first openable lid 20 covering the first compartment 16, a second compartment 22 formed therein for receiving a plurality of syringes with a second openable lid 24 covering the second compartment 22, and a third compartment 26 formed therein for mounting a pill pulverizer with a third openable lid 28 covering the third compartment 26. Preferably, each of the first openable lid 20, the second openable lid 24, and the third openable lid 26 are hingedly connected to the top side. Function and details of each of the compartments will be discussed in further detail below.

The front of the Medicine Reminder and Dispenser Apparatus 10 of the present invention contains an LED or LCD touch screen 30. This screen 30 and its associated menu provide the step by step programming functions necessary to operate the device 12.

The Medicine Reminder and Dispenser Apparatus 10 of the present invention is operable through two alternative power modes. The first power mode uses Alternating Current or AC by means of an included power cord and a standard household outlet. The second mode uses Direct Current through an internal rechargeable battery and charger cord or adapter.

The Medicine Reminder and Dispenser Apparatus 10 of the present invention preferably contains a maximum of approximately twenty medication wells 18 positionable, either removably or fixedly, within the first compartment 16. It should be noted that while the present invention has been described as having a maximum of approximately twenty medication wells 18, it is within the scope of the present invention to have more than twenty medication wells 18. Each medication well 18 is used and dedicated for a specific medication. Each medication well 18 is programmable in terms of when and how many pills to dispense per dose. At the appropriate time, the bottom or other portion of the medication well 18 is automatically released or opened releasing the medication therein into a passageway for dispensing, as will be described below.

As mentioned above, the second compartment 22 of the Medicine Reminder and Dispenser Apparatus 10 of the present invention is preferably refrigerated and has preloaded insulin syringes accessible through the second openable cover 24 by the user. The third compartment 26 of the Medicine Reminder and Dispenser Apparatus 10 contains a motorized pill grinder or crusher to pulverize solid pills. The user simply positions the pill or pills in the grinder and activates the grinder. The crushed pill or pills then fall into a cup 32 seated in an opening formed in the first side of the Apparatus 10.

Each medication well 18 of the Medicine Reminder and Dispenser Apparatus 10 of the present invention is individually programmable in terms of what medication they contain, how many pills they contain, how many are taken in an individual dose, and what time the dose is to be taken. The Medicine Reminder and Dispenser Apparatus 10 functions much like an alarm clock with multiple alarm settings. The program is set for a week or for a month. Each day, when the time arrives for a given medication to be taken, the Medicine Reminder and Dispenser Apparatus 10 releases the medicine from the designated medicine well 18 and dispenses the medicine through a passageway in the Apparatus 10 into a small holding tray 36 on the front side at the bottom of the device 12 of the present invention. A message, such as “Time for your Coumadin!”, is displayed on the screen 30. A prerecorded audio message, such as “Time for your Coumadin, Doris!”, is transmitted to the wireless speaker 14 which is located in a room where the patient or caregiver is most likely to be. The audio message is repeated at three minute intervals until deactivated when the medication is removed from the dispenser tray 36. Removal of the medicine records that dose as a successfully administered dose in the system's database. If there is any question of a missed dose, this record is easily accessible through the menu's search functions on the touch screen.

The Medicine Reminder and Dispenser Apparatus 10 of the present invention effectively functions to organize an individual's daily and weekly medications, dispense them at appropriate dosage times and persistently remind the individual when it is time to take them. The present invention is highly helpful for elderly widows or widowers living by themselves whose memories are less sharp. The Medicine Reminder and Dispenser Apparatus 10 is an excellent aid for professional or family caretakers of elderly individuals suffering from dementia and Alzheimer's diseases. Durably constructed, the present invention will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A Medicine Reminder and Dispenser Apparatus for dispensing medications to a user, the Apparatus comprising:
a substantially rectangular, tabletop device having a top side, a bottom side, a front side, a rear side, a first side, and a second side;
a medication receiving opening formed in the front side;
a first compartment formed in the top side;
a plurality of individual medication wells positioned within the first compartment, each medication well openable for releasing the medication into the medication opening; and
programming means mounted on the device for programming dispensing of medication from each medication well and audio and visual reminders as to when a certain medication is to be taken or administered;
wherein the device provides a digital daily, weekly or monthly medicine dispenser.

2. The Medicine Reminder and Dispenser Apparatus of claim 1 and further comprising:
a first openable lid hingedly connected to the top side of the device and completely covering the first compartment.

3. The Medicine Reminder and Dispenser Apparatus of claim 1 and further comprising a small holding tray removably receivable within the medication receiving opening on the front side of the device.

4. The Medicine Reminder and Dispenser Apparatus of claim 1 and further comprising:
a second refrigerated compartment formed in the top side of the device; and
at least one syringe positionable within the second compartment.

5. The Medicine Reminder and Dispenser Apparatus of claim 4 and further comprising:
a second openable lid hingedly connected to the top side of the device and completely covering the second compartment.

6. The Medicine Reminder and Dispenser Apparatus of claim 1 and further comprising:
a third compartment formed in the top side of the device;
a pill pulverizer mounted within the third compartment;
a third openable lid hingedly connected to the top side of the device and completely covering the third compartment; and
an opening formed in the first side of the device and fluidly connected to the pill pulverizer;
wherein upon positioning the pill within the pill pulverizer and activating the pill pulverizer, the pulverized pill falls into the opening.

7. The Medicine Reminder and Dispenser Apparatus of claim 6 wherein the crushed pill or pills fall into a cup seated in an opening.

8. The Medicine Reminder and Dispenser Apparatus of claim 1 wherein the apparatus is a self-contained, electrically powered, digital programmable device that contains, organizes and dispenses multiple individual medications on a preprogrammed dosing schedule.

9. The Medicine Reminder and Dispenser Apparatus of claim 1 wherein the audible alert is transmitted through a wireless, mobile audio speaker.

10. The Medicine Reminder and Dispenser Apparatus of claim 1 and further comprising:
an LED or LCD touch screen on the front side of the device;
wherein the screen and any associated menu provide the step by step programming functions necessary to operate the device.

11. The Medicine Reminder and Dispenser Apparatus of claim 1 wherein the device is operable through either Alternating Current or AC by means of an included power cord and a standard household outlet or Direct Current through an internal rechargeable battery and charger cord or adapter.

12. The Medicine Reminder and Dispenser Apparatus of claim 1 and further comprising:
a maximum of approximately twenty medication wells positionable, either removably or fixedly, within the first compartment.

13. The Medicine Reminder and Dispenser Apparatus of claim 1 wherein each individual medication well is used and dedicated for a specific medication.

14. The Medicine Reminder and Dispenser Apparatus of claim 1 wherein each medication well is programmable in terms of the medication they contain, how many pills they contain, how many are taken in an individual dose, and what time the dose is to be taken.

15. The Medicine Reminder and Dispenser Apparatus of claim 1 wherein the device has multiple alarm settings.

16. The Medicine Reminder and Dispenser Apparatus of claim 1 wherein the audio alert is a message.

17. The Medicine Reminder and Dispenser Apparatus of claim 10 wherein the video alert is a message displayed on the screen.

18. The Medicine Reminder and Dispenser Apparatus of claim 1 wherein removal of the medication from the medication receiving opening automatically records that dose as a successfully administered dose.

19. A Medicine Reminder and Dispenser Apparatus for dispensing medications to a user, the Apparatus comprising:
a substantially rectangular, tabletop device having a top side, a bottom side, a front side, a rear side, a first side, and a second side;
a medication receiving opening formed in the front side;
a first compartment formed in the top side;
a plurality of individual medication wells positioned within the first compartment, each medication well openable for releasing the medication into the medication opening;
a second refrigerated compartment formed in the top side of the device;
at least one syringe positionable within the second compartment;
a third compartment formed in the top side of the device;
a pill pulverizer mounted within the third compartment;
an opening formed in the first side of the device and fluidly connected to the pill pulverizer such that the pulverized pill falls into the opening; and
programming means mounted on the device for programming dispensing of medication from each medication well, dispensing a syringe from the second compartment, and audio and visual reminders as to when a certain medication is to be taken or administered;
wherein the device provides a digital daily, weekly or monthly medicine dispenser.

20. A method for dispensing medications to a user, the method comprising:
providing a substantially rectangular, tabletop device having a top side, a bottom side, a front side, a rear side, a first side, and a second side;
forming a medication receiving opening in the front side;
forming a first compartment formed in the top side;
positioning a plurality of individual medication wells within the first compartment;
releasing the medication into the medication opening;
programming dispensing of medication from each medication well and audio and visual reminders as to when a certain medication is to be taken or administered; and
providing a digital daily, weekly or monthly medicine dispenser.
